(19) United States
(12) Patent Application Publication
(10) Pub. No.: US 2013/0016206 A1
(43) Pub. Date: Jan. 17, 2013

(54) DEVICE AND METHOD FOR EDGE- AND SURFACE INSPECITON

(71) Applicants: Bjorn Zimmer, Dresden (DE); Gunther Wolf, Radebeul (DE)

(72) Inventors: Bjorn Zimmer, Dresden (DE); Gunther Wolf, Radebeul (DE)

(21) Appl. No.: 13/351,095

(22) Filed: Jan. 16, 2012

Related U.S. Application Data
(63) Continuation-in-part of application No. PCT/EP2010/055744, filed on Apr. 28, 2010.

(30) Foreign Application Priority Data
Jul. 16, 2009 (DE) DE102009026186.9

(51) Int. Cl. H04N 7/18

(52) U.S. Cl. 348/87

(57) ABSTRACT

A device for edge- and surface inspection of flat objects, particularly patterned, sawn, broken, or partial wafers, and wafers of any kind on film frames, dies, displays, glass-ceramic or metal samples or batches of such materials, Die waffle packs, and multichip modules, comprises an inspection head, with an object lens and a bright field illumination unit having a light source and an optical assembly, wherein light generated by said light source is directed by said optical assembly towards said object with an angle of incidence for illuminating said object and wherein said light is reflected from said object in the direction of said object lens; and a support for supporting said object at said edge, said support having several support arms along said edge, wherein at least one of said support arms is removable from said edge while the edge is inspected in the range of said removable support arm.

### RELATED APPLICATIONS

This application is a continuation-in-part of International Application PCT/EP2010/055744 filed Apr. 28, 2010, and which specified the United States, and which is based on and claims priority to German Application DE 10 2009 026 186.9 filed Jul. 16, 2009.

### TECHNICAL FIELD

The invention relates to a device for edge- and surface inspection of flat objects having an edge and a surface, in particular patterned wafers, sawn wafers, broken wafers, partial wafers, and wafers of any kind on film frames, dies, displays, glass-ceramic or metal samples or batches of such materials, Die waffle packs, multichip modules like MCMs.

In different branches of industry, edges and surfaces of products are inspected for defects using optical imaging methods. In semiconductor and solar cell industries such products are among other things wafers. Wafers are discs of semiconducting material, ceramic material or glass. In different applications the edges of wafers are inspected fully or at least in large segments. Such an inspection is called “edge inspection”. Different kinds of defects are relevant regarding wafer edges. Such defects can be impurities by particles, coating residuals, etch or polish residuals and so on. Mechanical defects like chip-outs, cracks, micro cracks and scratches may be present. Delamination occurs also, so called “flakes” at layer edges especially of resist layers, but also other layers like oxides, nitrides, hard masks, etc. Further defects are irregularities of the layer edges, uneven distance of the layer edge from the wafer edge, also known as fluctuating edge bead removal (EBR), as well as bays, tails, cracks, detachment, and a varying or wrong angle of the slope.

The lateral resolution required for the detection of such defects increases with the development of the general production technology. The desired resolution for edge inspection is typically in the range of 5 μm. At the same time devices are desired that allow a high inspection throughput.

It is a general object of the development to obtain the maximum number of “chips” from a wafer. It is, therefore, intended to extend the production area closer to the edge. There is an increasing interest for edge inspection. Particularly with the introduction of immersion lithography, the edge region becomes more important. A water drop is used and runs between the optical component and the wafer even across the edge region. Impurities are easily collected by the water drop.

Similar problems need to be solved in other branches of industry. In the flat-panel industry the displays need to be checked for defects during production. Here, too, the edges are fully examined to detect impurities and mechanical defects. In the solar panel industry mechanical edge defects, for example chip-outs and micro cracks play an important role due to the high stress load of large cells during their lifespan. According to present standards the cells have a size from 100×100 mm² to 156×156 mm².

All such applications have in common the requirement for fast examination, a high number of usually similar specimens and the application of sensors to generate large scale images of the edges of the specimen. Similar specimen are, depending on the application, wafers, solar cells, displays, etc. The large scale images are generated with different devices depending on the kind of defect. Optic photographic systems are for, example, area scan cameras or line scan cameras. Point related working systems are, for example, detectors for measuring the reflection of optical beams, microwaves, or acoustic waves.

In addition to the edge inspection described above full or partial two dimensional inspection of wafers and other specimen is also important.

### PRIOR ART

Optical inspection systems for edge and surface inspection often use macro lenses with a set magnification and aperture settings. Such systems do not allow the adjustment of the resolution of the images according to the requirements of the user. They also do not allow an adaption of the depth of focus according to the requirements of the wafer inspection.

WO 2008 152 648 A2 discloses an edge inspection system. The edge inspection system comprises a bright field illumination assembly to illuminate a desired area. The light is directed to that area by means of beam splitters. The light is reflected at the inspection area and passes through the beam splitter to the detector. With the use of a beam splitter only a small portion of the light of the light source is used in the known assembly. Each beam splitter reduces the intensity of light by 50%. Therefore, high intensity light sources are needed. This makes these systems expensive.

For some applications it is necessary to hold the wafer only at the outer edge during inspection. Such an application is, for example, the inspection of wafers polished on both sides. Another example is wafers structured on both sides, where the back side of the wafer is as sensitive as the top side. It may only be touched several millimeters at the edge. A system that fulfills such conditions is called an “edge grip system”. Known edge grip systems need to re-grip or transfer the wafer for inspection of the backside or at least the portion of the wafer edge that was previously covered by the edge grip system. Usually the wafer is flipped, so that the previously covered part of the edge can be inspected in a second step. The interruption of the inspection and the additional handling make these systems more prone to errors and slow. Thereby, the throughput is limited.

### DISCLOSURE OF THE INVENTION

It is an object of the invention to provide an edge inspection system of the above mentioned kind, that enables the inspection of surfaces and/or edges at a high inspection rate and high resolution.

According to an aspect of the invention the object is achieved with an inspection system of the above mentioned kind comprising an inspection head, with an object lens and a bright field illumination unit having a light source and an optical assembly, wherein light, generated by said light source, is directed by said optical assembly towards said object with an angle of incidence for illuminating said object and wherein said light is reflected from said object in the direction of said object lens; and a support for supporting said object at said edge, said support having several support arms along said edge, wherein at least one of said support arms is removable from said edge while the edge is inspected in the range of said removable support arm.

The invention also provides a method which increases the throughput for the edge inspection for wafers which may only be supported at the edge which is called “edge grip”. An important contribution to the edge inspection is the simultaneous inspection of apex, front side and back side of the wafer in one imaging cycle without changing grip or transferring the wafer like in the previous state of the art.

For that purpose a support is provided supporting the objects at their edge. Thereby, the device enables inspection of wafers which are sensitive on both sides. Preferably, the support is rotatable. The wafer may then be rotated in such a way that the edge of the wafer can be continuously moved under the camera.

To be able to simultaneously take an image of the entire edge especially of the top, of the side and of the back with the inspection heads described above, support arms are provided. Each of the support arms can be retracted from the edge area during inspection. While the top and the side of the wafer can be continuously imaged during rotation of the wafer along its axis, the back of the wafer is partially covered by the support arms. The retraction of the support arm when passing the camera during inspection allows the continuous imaging of the back side of the wafer edge even for a 360° rotation of the wafer about its surface normal. The wafer need not be set down and gripped at another position. The position need not be changed. With retractable support arms it is possible to take an image of the entire edge without the need of assembling several parts of the image for different sections of the edge at a later stage.

The optical assembly may provide that the angle of incidence of the light on the mirror is not equal to zero degrees and the light generated by the light source is reflected along the middle axis of the object lens. The optical assembly may comprise an off-axis mirror with a reflecting surface, which forms an angle with the object surface. This may be achieved by the illumination itself or by an additional object mirror on the side of the object. An angle between 5° and 15° has been proven beneficial. It is understood that in different applications the angle may be larger or smaller.

The light beam of the bright field illumination assembly is incident on the surface with an angle of incidence. The angle of incidence is understood to be the angle between the incoming light beam and the surface normal. From the object surface the light beam is reflected in the direction of a camera or the like parallely to the middle axis of the object lens. This is a direct reflection of the bright field light.

Contrary to known assemblies, the use of additional optical elements like a beam splitter in the beam path in front of the object lens is avoided. Thereby, for identical radiance of the light source a higher light intensity at the surface and hence in the camera is achieved. The more light that enters the camera the shorter is the required exposure time. Short exposure times increase the throughput. Alternatively, short exposure times allow a reduction of the required power of the light source. Without an additional mirror the minimum angle of incidence is limited by the diameter of the object lens. The angle of incidence is equal to the angle of reflection. A larger angle of reflection limits the resolution, due to the decrease of the usable depth of focus. This problem is overcome by the present invention.

Preferably, the optical assembly of the bright field illumination assembly comprises a further mirror arranged along the optical path in front of the object mirror. By using two mirrors the angle of incidence can be kept small while maintaining a compact design. A small angle of incidence is desirable because the reproduction quality is enhanced. As the object lens is tilted, the focal plane of the object lens is not parallel to the surface. Only a strip of the inspected area falls in the focal plane. The areas having a different distance do not fall on the focal plane. If this is compensated by a larger depth of focus, the quality of the photograph decreases. Reflexes at edges are reduced by small angles of incidence. The defects intended to image by bright field illumination are therefore easier to detect.

The assembly according to the invention is particularly preferable for imaging with a line scan camera. Here the incidence of light occurs at an angle α. The tilt is carried out in the plane perpendicular to the longitudinal axis of area acquired by the line scan camera. This ensures that even with the tilted beam the full area of inspection lies in the depth of focus of the line sensor. This image is taken without loss of contrast.

The assembly according to the invention can, however, also be applied with area scan cameras. The depth of focus can be adapted according to the known method by Scheimpflug. The loss in contrast at high resolution images due to the tilt of illumination and projection lens for points of view with higher distance from the center line of the image is avoided. By the method according to Scheimpflug the camera sensor is positioned with an angle different to the perpendicular orientation of the imaging beam in such a way that the path difference between object and object lens for an off axis area of the image caused by the tilted position of the object lens is compensated by an equally sized path difference between object lens and camera sensor. This means that the camera is tilted in the beam line that its sensor falls again into the image side focal plane of the object lens caused by the object lens tilting. With such an assembly it is ensured that even with area scan cameras the advantages of the previous mentioned direct reflection of the bright field can be used. At the same time, the entire inspection area is in the focus range of the image.

In a preferred embodiment of the invention the inspection head comprises a dark field illumination assembly. By dark field illumination the edges are strongly enhanced. The use of a dark field illumination assembly, therefore, facilitates the retrieving of defects with a component perpendicular to the surface. Examples are dust particles, scratches, chip-outs and edges. An additional dark field illumination assembly in the same inspection head allows, with just a little more effort, to make different kinds of defects more visible and easier to distinguish.

Preferably, the dark field illumination unit comprises a light source extending all around the object. Thereby it is achieved that the object is well illuminated. The illumination allows the detection of structures in any position and reduces the formation of shades behind protrusions.

In a preferred modification of the invention, the light source comprises a plurality of light emitting diodes (LED) emitting light. Light emitting diodes are cheap. Furthermore, light emitting diodes emit less heat with the same intensity of radiation compared to conventional lights. For image acquisition, much light is desirable to obtain short exposure times. Contrary to known illumination with conventional lights, heating of the inspected surface is avoided when using light emitting diodes. Light emitting diodes usually do not fail all of a sudden but their light intensity reduces slowly. This provides sufficient time for exchanging the LEDs. The decreasing intensity can be compensated by a higher diode current until the LED is exchanged. The time for exchanging the LED can be controlled which is not possible with conventional lights.

Preferably, optical elements are provided for focusing the light from the light emitting diodes. By focusing the light of the light emitting diodes the area imaged by the camera is better illuminated. Areas that are not imaged do not need to be illuminated. This ensures that the light is optimally utilized while illuminating the object. With a higher light intensity the exposure time can be reduced. The throughput is increased.

In another preferred modification of the invention the object lens is a video lens mounted in retro position. A video is cheaper than a macro lens. The imaging properties of a video lens in retro position are equivalent to those of a macro lens. In the present invention the distance between the object and the lens is smaller than the distance between the object lens and the sensor. Thus, the use of a video lens in retro position is achieved by adapting the beam path to the required geometry. The optical quality of the video lens is used and the image is improved.

Preferably, the video lens has a set focal length and means are provided for adjusting the magnification of the video object lens by adjusting the distance between the object lens to the object surface. An increased distance between the object lens and the sensor and a reduction of the distance between the object lens and the object causes an increased reproduction scale. With the use of a macro lens the magnification is changed by replacing the object lens and hence additional costs are involved, the optical assembly according to the present invention provides magnifications which are easy to adapt to different inspection situations. Magnifications with a factor higher than two may be achieved.

In a preferred modification of the present invention an iris aperture is provided at the inspection head. By changing the aperture of the iris aperture the depth of focus can be adapted to the needs. For rough surfaces the depth of focus can be adjusted so that a sharp mapping of the full vertical range is achieved. The opening of the iris aperture is reduced to achieve an increased depth of focus. With very smooth surfaces only a small depth of focus is necessary. In this case the opening of the iris aperture can be increased to collect more light and thereby either save exposure time or light intensity. For surfaces with low reflectivity the iris aperture can be opened. Thereby, more light is available at the camera.

In a further modification of the present invention the camera in the inspection head is a line scan camera. During edge inspection of a round wafer the edge is usually moved under the camera by rotation of the wafer. It was shown that for most inspection tasks it was sufficient to use a line scan camera. Thereby, a rectangular image of the unrolled edge can be automatically generated without the need to either mathematically remove redundant parts of the image or to merge portions of images. As the costs for camera sensors increase with increasing areas the use of line scan cameras is also cheaper compared to area scan cameras with equivalent resolution. By the simpler solution of the previously mentioned problem with the depth of focus assembly and adjustment of a system with a line scan camera are simplified.

The described aspects of the invention can also be used with an area scan camera. For the use with edge inspection area scan cameras require more efforts, but generate a totally undistorted image. In some cases, therefore, they facilitate the analysis of textures and defect characteristics.

In a preferred modification of the invention a further inspection head for back side inspection is provided. The use of a back side inspection head allows the simultaneous inspection of the wafer back without the need to flip the wafer. This reduces the inspection time and increases the throughput.

Furthermore, in a preferred modification of the present invention an inspection head for apex inspection is provided whereby the side of the edge can also be imaged simultaneously. This is also carried out without flipping the wafer and, therefore, also increases the throughput.

As the wafer can only be placed on a limited number of support arms, it will be periodically sagging between the support points. Besides, due to the process related strain in the wafer, different extents of sagging of the wafer are expected which are not totally predictable. Furthermore, while retracting at least one of the support arms an intensified sagging of the wafer edge is noted. With such effects with a force free supported wafer, the conditions for depth of focus for high resolution images cannot be fulfilled without correction. Therefore, sensor means to detect the vertical edge position are provided in a preferred modification of the present invention. The sensors detect the vertical position of the wafer edge and generate a signal proportional to the vertical edge position.

In a preferred modification of the present invention further sensor means for detection of the lateral edge position are provided. Due to tolerances in the wafer diameter and unavoidable uncertainties on the support, the position of the wafer edge relative to the inspection head can change during inspection. Therefore, it is necessary that sensors detect the lateral position of the wafer edge and generate a signal. The tracking of the lateral edge position is also required to fulfill the condition of sharpness of an apex-camera optimally adjusted to image the wafer edge.

Preferably, adjusting means are provided for adjusting the inspection head according to a signal of the sensor means. To ensure that the conditions of sharpness for the top and the back are met at all times, the inspection heads for the wafer edge are vertically tracked. So that the resulting images capture the desired region and the condition of sharpness is met at all times, the inspection heads can also be tracked laterally. An apex-inspection head is tracked laterally for adherence of the condition of sharpness. The control signal for tracking is generated from the signal of the edge sensors.

According to an aspect of the invention the object is solved by a method for edge inspection of flat objects having an edge and a surface, in particular patterned wafers, sawn wafers, broken wafers, partial wafers, and wafers of any kind on film frames, dies, displays, glass-ceramic or metal samples or batches of such materials, Die waffle packs, multichip modules like MCMs, with an inspection head, the method comprising the steps of:

lifting one of said objects onto a support at well defined support points,

loading an edge inspection program,

positioning said inspection head,

rotating said object,

taking an image of said edge of said one of said objects,

saving said images on a computer,

removing said object,

and wherein said support has several support arms along said edge, wherein at least one of said support arms is removed from said edge while an image of said edge is taken in the range of said removable support arm.

The steps can be carried out partially simultaneously. Preferably, steps d) to g) are carried out simultaneously. Optionally, the wafer can be fixed while steps b) to g) are carried out.

The method presented here forms a possibility for automated edge inspection. The throughput increases, as manual engagement is not necessary anymore. It turned out that applying the wafer to defined support points is sufficient for numerous inspection tasks. A planar support is only necessary for particularly high requirements. By data acquisition during rotation a two dimensional image is produced, that depicts the unrolled edge. With a fixed distance to the edge of the coating from the edge of the wafer it is described as a straight line. Deviations can easily be disclosed.

In a preferred embodiment of the method according to the present invention, the inspection head is continuously readjusted during the rotation of the wafer. This ensures a sharp image at all times.

Preferably, the method comprises that single support points are released so that the object edge is not obscured during inspection of the back. Thus, an inspection of the entire edge can be effected in a single run. An interruption and repositioning of the wafer in a changed position is avoided. Thus, the throughput of objects is increased.

Preferably, the method comprises the use of bright and/or dark field illumination. As each kind of illumination more clearly images different defects, it is preferred to optimize the illumination respectively. Thus, one can search for one or the other kind of defect separately as well as for different defects simultaneously.

Further modifications of the invention are subject matter of the subclaims. An embodiment is described below in greater detail with reference to the accompanying drawings.

### BRIEF DESCRIPTION OF THE FIGURES

FIG. 1 is a perspective view of a device for edge inspection with a wafer.

FIG. 2 shows the device of FIG. 1 without a wafer.

FIG. 3 shows a detailed lateral view of the device of FIG. 1.

FIG. 4 shows schematically the optical path of the bright field illumination assembly.

FIG. 5 shows the inspection head in a sectional drawing.

FIG. 6 is a perspective view of the inspection head.

FIG. 7 shows perspectively a device for edge inspection with sensors for detection of the edge location.

FIG. 8 is a top view in which the movement of the support arms during inspection is illustrated.

### DESCRIPTION OF THE EMBODIMENT

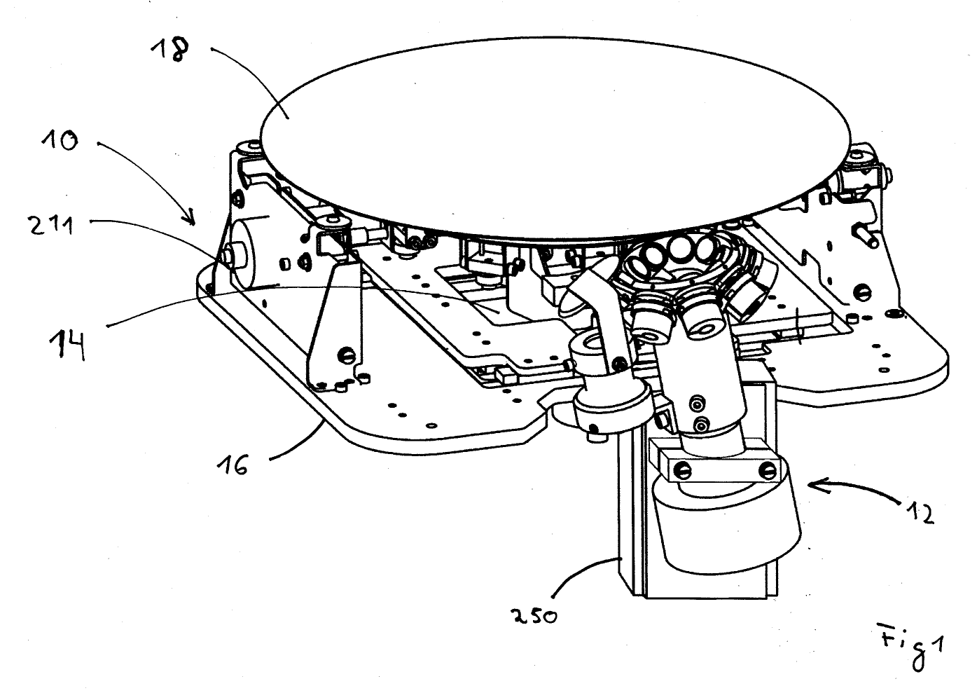

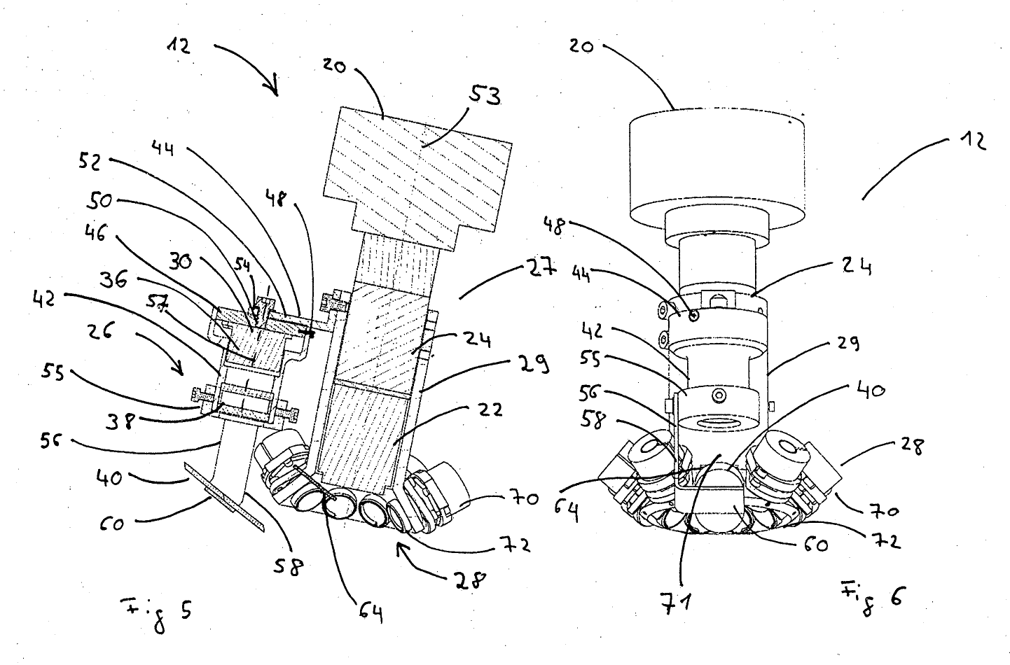

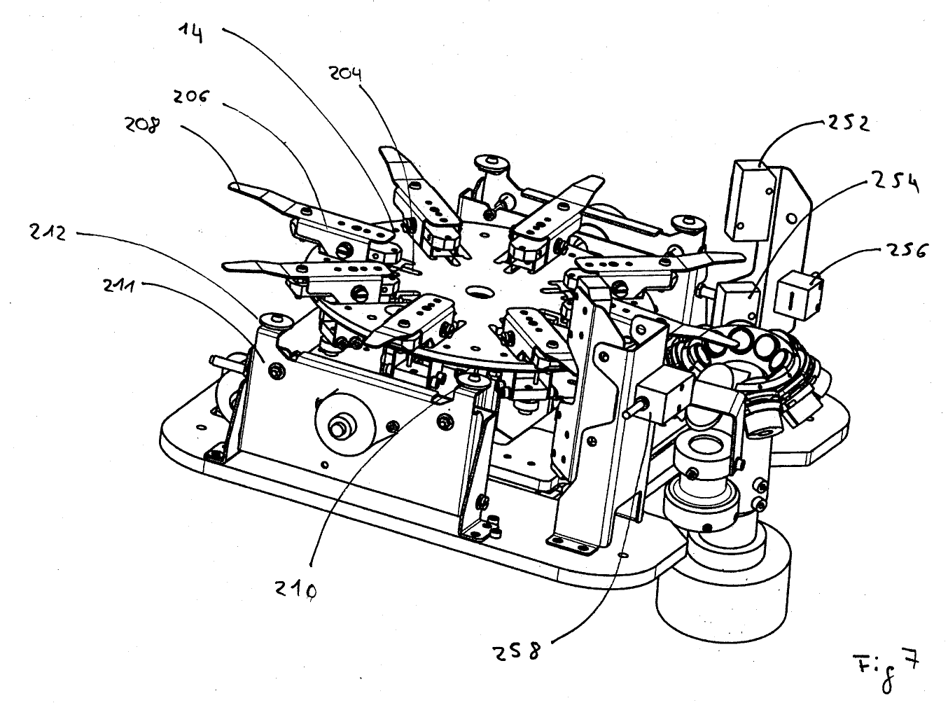

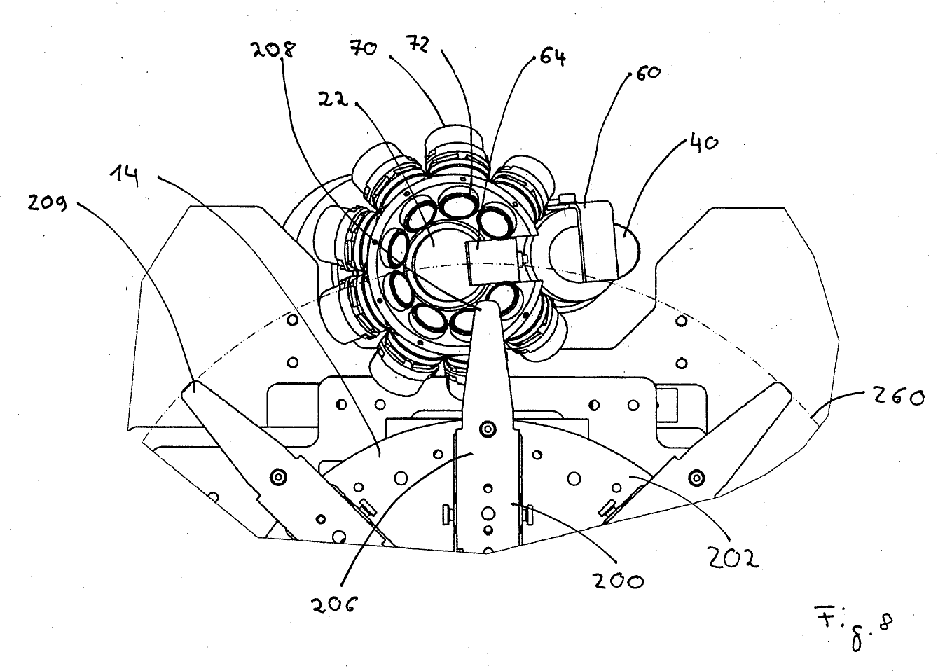

FIG. 1 shows an edge inspection system generally designated with numeral 10. The edge inspection system 10 comprises an inspection head 12, a wafer support 14 and a base plate 16. A wafer 18 is located on the wafer support 14. The inspection head 12 is shown in FIGS. 5, 6, and 8. The inspection head 12 comprises a camera 20, an object lens 22, a tube 24 and a bright field illumination assembly 26 for bright field illumination. Furthermore, a dark field illumination assembly is provided for dark field illumination, generally denoted with numeral 28.

The object lens 22, the camera 20 and the tube 24 form a camera assembly 27. The camera assembly 27 further comprises a camera housing 29.

A light emitting diode (LED) 30 is provided as a light source 30 of the bright field illumination assembly. A light bulb or a diffuse ring illumination is used in an alternative embodiment, which is not shown. An even illumination is achieved for bright field illumination. In order to prepare a parallel light path, a collimator 36 in the form of a lens is provided at the LED 30. The light emitted by the light source impinges upon a first planar tilted mirror. A diffuser 38 in the beam path between collector 36 and the tilted mirror causes a uniform light distribution.

The illumination assembly 26 has a housing 42. The LEDs 30, the collimator 36 and the diffuser 38 are mounted in the housing 42. The housing 42 is designed rotationally symmetrical around an optical axis 57.

The LEDs 30 are arranged at a closed end 44 of the housing 42. The closed end 44 is closed with a disc 46. The disc 46 has a diameter which is smaller than the inner diameter of the housing 42 at the closed end 44. The disc 46 is fixed to the housing 42 with screws 48. The disc has a centered threaded hole 50. At one end 54 an “L” bracket 52 is bolted together with the disc 46. The “L” bracket 52 has a second end, which is bolted to the camera housing 29. The optical axes of the bright field illumination assembly 57 and the camera assembly 53 are parallel to each other.

A retainer ring 55 is provided at the housing 42 of the bright field illumination assembly. The retaining ring 55 has two screws for the connection to the housing 42. A reflector holder 56 is provided at the retainer ring 55. The reflector holder consists of an “L” shaped angled plate 56. The angle of the plate divides the plate 56 into a long section 58 and a short section 60. The long section 58 is bolted to the retaining ring 55. The mirror 40 is connected to the short section 60. The first mirror 40 is adjusted so that the light beam exiting the bright field illumination assembly is reflected in a desired direction. In the present embodiment, the light beam reflected from the first mirror 40 hits a second object sided planar mirror 64. The object sided mirror 64 is provided at the lower end of the camera housing 29.

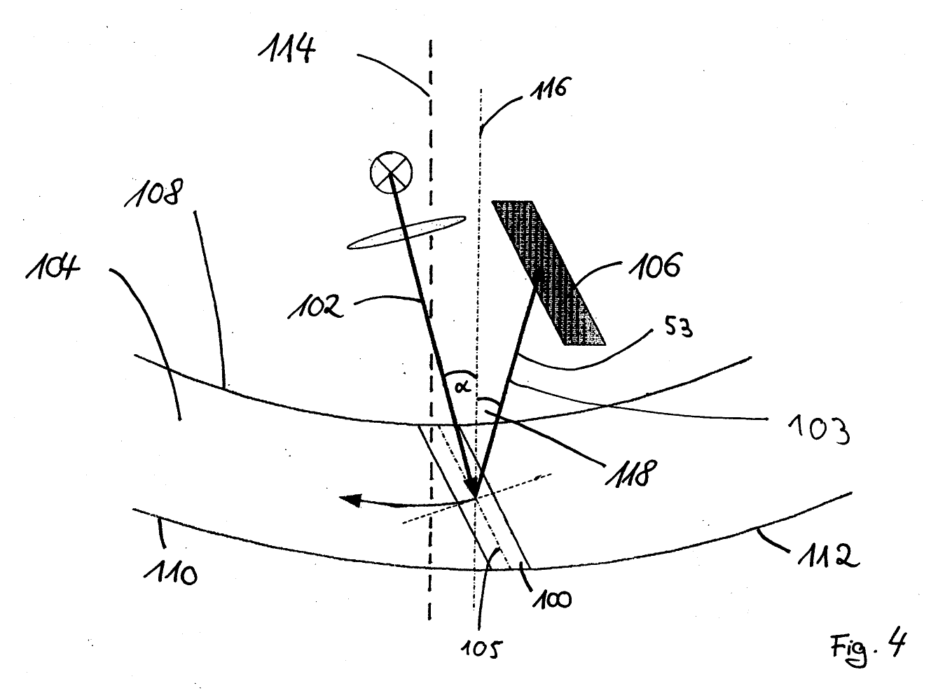

The object sided mirror 64 is adjusted so that the light beam illuminates the area of the inspection well. By use of the two mirrors 40, 64 the light beam forms an acute angle with the surface normal, the angle α. This is illustrated in FIG. 4. The light beam 102 is reflected off the surface of the wafer so that the light beam traverses the object lens 22 parallel to the optical axis of the camera assembly 20. The direction vectors of the incoming and the reflected light beam 102, 103 span a plane. In the area of inspection 100 the spanned plane is perpendicular to the radius 105 of the wafer. In this embodiment the angle of incidence and the emerging angle α of the light are 5° each.

The mirrors 40 and 64 are formed as full plane mirrors with a reflectivity higher than 90%. The object lens 22 maps the surface of the wafer 18 to the sensor surface of the camera 20. The object lens is a video lens in retro position. This allows a sharp imaging. Furthermore the magnification can easily be adjusted to different needs by changing the length of the tube 24. The focal point of the object lens is hereby changed as well. Due to the changed focus, the distance between object lens and surface as well as the illumination need to be adapted.

The object lens contains an iris aperture in the beam path. The iris aperture allows the adjustment of the depth of focus. The camera 20 is formed as a line scan camera. The focal plane forms an angle with the wafer surface. The depth of focus is chosen so that the border areas of the inspection area are sharply imaged.

The dark field illumination assembly 28 is designed circularly around the object lens 22. The dark field illumination assembly 28 consists of eight light emitting diodes 70. Each of the light emitting diodes 70 is provided with a focusing optic 72. The focus is adjusted so that the area 100, FIG. 4, captured by the camera 20 is illuminated ideally. It is understood that other light sources can be used instead of light emitting diodes. A gap 71 in the ring of light emitting diodes is provided for the second mirror 64. The light of the dark field illumination assembly 28 hits the surface at an angle of incidence of about 50-60°. It is understood that this angle can also be larger or smaller. The line scan camera is 20 is oriented along the diameter of the wafer 18.

FIG. 4 illustrates the method of execution of the edge inspection. An area of interest 100 is illuminated by a light beam 102 at an angle of incidence α. The light beam is reflected off the surface 104 of the wafer onto the sensor 106 of the camera. The area of interest 100 ranges from an inner radius 108 to an outer radius 110. The outer radius is a couple of pixels outside the edge 112 of the wafer, to ensure a secure imaging of the edge of the wafer which is used as a reference. The camera 20 and the bright field illumination assembly 26 are provided at the inspection head 12.

The wafer 18 rotates around its rotation axis 114 parallel to the surface normal 116. The mapping of the sensor 106 of the line scan camera forms the area of interest. The angle 118 between surface normal and optical axis of the camera assembly equals the angle of incidence α. The incident beam 102 and the reflected beam 53 form a plane which is perpendicular to the diameter of the wafer. The long axis of the line sensor 106 is oriented parallel to a diameter of the wafer. Therefore the interesting area is also parallel to a diameter of the wafer so that the depth of focus only needs to cover a small resulting tilt in the direction of movement. The whole edge is imaged in one 360° rotation by rotation of the wafer. This produces a two dimensional image that depicts the unrolled edge.

In an embodiment which is not shown, an area scan camera is provided. With the area scan camera the camera sensor is tilted against the beam axis 53 that the focus range is according to the Scheimpflug method magnified to the whole area 100 which is tilted against the beam.

A trigger synchronizes the rotational motion with the image capturing.

The inspection head is positionable along the three spatial axes. A respective motorized device 250 is shown in FIG. 1. Herewith a change in position of the edge can be compensated for. The position of the edge can vary in two ways. On one hand, it can vary along the rotational axis of the wafer. A vertical sensor consisting of a transmitter 256 and a receiver 258 is provided for that. A signal proportional to the vertical displacement is generated. This control signal is sent to a stepping motor in the device. The stepping motor tracks the inspection head so that the edge is located in the focus of the inspection head again. On the other hand the distance of the edge to the rotational axis can vary. For detection of the edge position in this direction a lateral sensor system 252, 254 with transmitter and receiver is provided. This lateral sensor systems 252, 254 acts as a curtain of light. It detects the lateral position of the edge relative to the inspection head and controls the motors accordingly so that the edge always appears at the same position in the image. The vertical tracking is important for sharp photographs in high resolution imaging. For lower requirement, one might be able to do without vertical tracking without abandoning the idea of the invention. The lateral tracking is important for sharp imaging of a not shown camera inspection system for inspecting the wafer's front face and to ensure that the wafer edge is always located a couple of pixels away from the image border 110 inside the acquired image. For lower requirements or missing of an apex imaging, one can do without lateral tracking without abandoning the idea of the invention. Assurance of the wafer edge 112 position between 108 and 110 can also be provided by a sufficiently long line sensor. It is understood that the mentioned sensors 252, 254 and 256, 258 can also operate inductively, capacitively, or with a combination of optically, inductively, and capacitively. Also a mechanical sensor is possible.

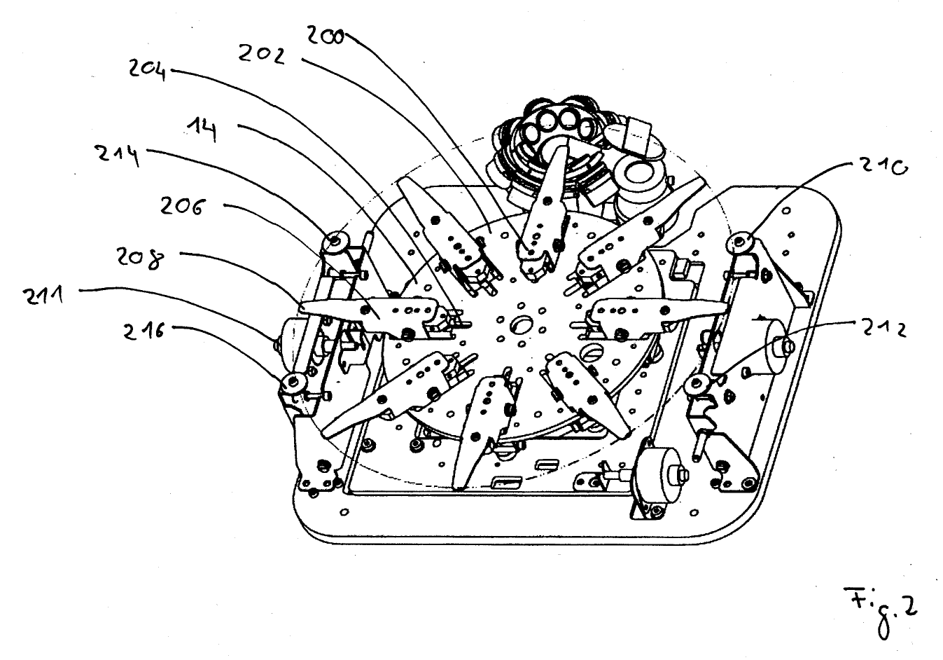

FIG. 2 allows a view to the wafer support 14. The wafer support comprises eight superstructural parts 200 that are arranged radially around a rotatable plate 202. Plate 202 is provided with eight radial elongated holes. This allows the adjustment of the radial distance between the superstructural parts and the rotational axis of the plate. The superstructural parts 200 are provided with sheets 206 which point radially outwards. At the outer ends the sheets 206 are provided with a diminution 207. These form support arms 208. During inspection, the wafer bears on the support arms 208. Four mushroom shaped supports 210, 212, 214, 216 serve as an interim storage for the wafer after a not shown robot arm fed the wafer to the inspection device. The wafer support 14 can be lifted by a mechanism. Hereby the wafer bears on the wafer mount. After the inspection occurred, the wafer support 14 is lowered again and the robot arm grips the wafer and removes the wafer. Alternatively the supports 210, 212, 214, 216 can also be provided to be movable in height.

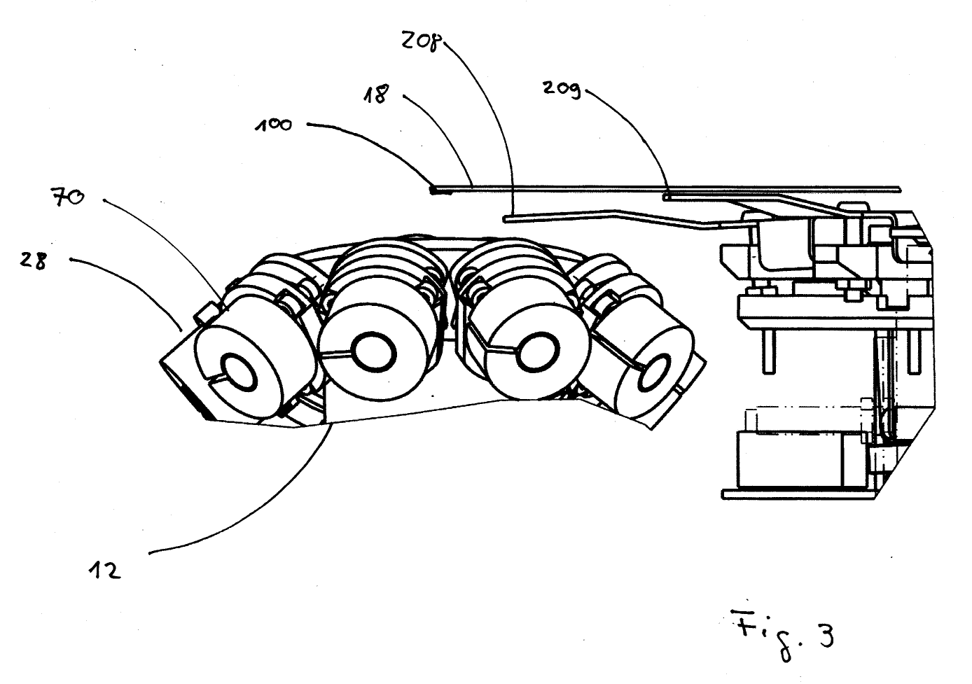

The wafer 18 bears with its edge region on the support arms 208 of the super structural parts 200. The edge region of the backside is therefore not fully accessible for inspection. FIG. 3 shows a support arm 208 as it is lowered and retracted as soon as the inspection head inspects this place of the edge of the wafer. The wafer is still stably located on seven of the eight support arms. In FIG. 8 the situation is described from a top view. A dotted line 260 shows the radius up to which the superstructural parts 200 partially cover the edge of the wafer when in home position. The support arm that is located near the object lens is retracted, therefore the opening of the object lens is not any longer covered by one of the eight support arms. If the wafer turns again, the retracted support arm is brought back into a position where it supports the wafer. By retracting and repositioning of the support that would cover the edge during inspection it is ensured that the whole edge can be inspected in one single 360° rotation of the wafer. The use of eight support arms ensures that the wafer is always stably positioned. The retraction and repositioning of the supports can be controlled by motors or mechanical. A calotte shaped outline is suitable for mechanic control.

In another embodiment, which is not shown, up to three inspection heads are provided whereby one inspection head inspects the front side of the edge of wafer, one head the backside of the edge of the wafer, and the third head inspects the apex of the edge of the wafer. It is understood that the device 10 can also comprise a head for surface inspection.

The inspection is conducted as follows. A wafer is placed in the middle of the supports 210, 212, 214, 216. Then by lifting the wafer support the wafer is taken over by the support arms 208. Usually it is not necessary to fix the wafer against movement, but fixing can be done by vacuum, if needed. A previously chosen edge inspection program is loaded and started. The radial position of the edge of the wafer is identified by sensors. The inspection head or the inspection heads are moved towards the center of the wafer until the optimal focal point is reached. The wafer starts rotating. The line scan camera starts acquiring images of the edge. The image acquisition is synchronized by output of position synchronized trigger pulses. The camera is able to acquire the images with reference to the trigger pulses. A color correction when using color cameras is also known. The images are saved on a computer. After a full image of the edge is acquired, the rotation is stopped. The inspection head or the inspection heads are moved in a way that the wafer can be removed unhampered. The wafer support 14 is lowered and by that the wafer is repositioned at the supports 210, 212, 214, 216. Then the wafer is removed. When inspecting the backside of the wafer the supports arms that would obscure the object lens are separately retracted. When the respective support arm has passed the object lens it is extended again so that the wafer once again bears on all support arms.

What is claimed is:

1. A device for edge- and surface inspection of flat objects having an edge and a surface, in particular patterned wafers, sawn wafers, broken wafers, partial wafers, and wafers of any kind on film frames, dies, displays, glass-ceramic or metal samples or batches of such materials, Die waffle packs, multichip modules like MCMs comprising:
an inspection head, with an object lens and a bright field illumination unit having a light source and an optical assembly, wherein light, generated by said light source, is directed by said optical assembly towards said object with an angle of incidence for illuminating said object and wherein said light is reflected from said object in the direction of said object lens; and
a support for supporting said object at said edge, said support having several support arms along said edge, wherein at least one of said support arms is removable from said edge while the edge is inspected in the range of said removable support arm.

2. The device of claim 1, and wherein said angle of incidence is not equal to zero degrees and wherein said light generated by said light source is reflected along the middle axis of said object lens.

3. The device of claim 2, and wherein said optical assembly comprises an off-axis mirror with a reflecting surface, said reflecting surface forming an angle with said object surface.

4. The device of claim 3, and wherein said bright field illumination unit is provided with a second mirror in the optical path before said off-axis mirror.

5. The device of claim 1, and wherein said inspection head further comprises a dark field illumination unit.

6. The device of claim 5, and wherein said dark field illumination unit comprises a light source extending all around said object.

7. The device of claim 6, and wherein said light source comprises a plurality of light emitting diodes (LED) emitting light.

8. The device of claim 7, comprising optical elements for focusing said light from said light emitting diodes.

9. The device of claim 1, and wherein said object lens is a video object lens mounted in retro position.

10. The device of claim 9, and wherein said video object lens has a set focal length and means are provided for adjusting the magnification of said video object lens by adjusting the distance between said object lens from said object surface.

11. The device of claim 10, and wherein an iris aperture is provided in said inspection head for adjusting the depth of focus range.

12. The device of claim 1, and wherein the inspection head comprises a line scan camera.

13. The device of claim 1, and wherein the inspection head comprises a plane camera, and wherein the range of depth of sharpness in the direction of the beam plane is adjusted by an assembly according to the Scheimpflug method.

14. The device of claim 13, and wherein the support is rotatable.

15. The device of claim 14, and wherein sensor means are provided for determining the position of said edge of said object.

16. The device of claim 15, and wherein adjusting means are provided for adjusting the said inspection head according to a signal of said sensor means.

17. The device of claim 16, and wherein one or more further inspection heads are provided for back side inspection or for inspecting the front side of said object edge.

18. A support for flat objects having an edge and a surface, in particular patterned wafers, sawn wafers, broken wafers, partial wafers, and wafers of any kind on film frames, dies, displays, glass-ceramic or metal samples or batches of such materials, for use in a device for edge and/or surface inspection, comprising a plurality of support arms along said edge of said object to support said object, wherein at least one of said support arms is removable from said edge while the edge is inspected in the range of said removable support arm.

19. Method for edge inspection of flat objects having an edge and a surface, in particular patterned wafers, sawn wafers, broken wafers, partial wafers, and wafers of any kind on film frames, dies, displays, glass-ceramic or metal samples or batches of such materials, Die waffle packs, multichip modules like MCMs, with an inspection head, the method comprising the steps of:
lifting one of said objects onto a support at well defined support points,
loading an edge inspection program,
positioning said inspection head,
rotating said object,
taking an image of said edge of said one of said objects,
saving said images on a computer,
removing said object,
and wherein said support has several support arms along said edge, wherein at least one of said support arms is removed from said edge while an image of said edge is taken in the range of said removable support arm.

20. The method of claim 19, and wherein the position of the edge is determined by sensors or by processing of said images.

21. The method of claim 20, and wherein said inspection head is adjusted during rotation of said object.

22. The method of claim 20, and wherein said object is secured against slipping during rotation.

23. The method of claim 20, and wherein bright field- and dark field illumination is used for inspection.
